(19) United States
(12) Patent Application Publication
(10) Pub. No.: US 2005/0032938 A1
(43) Pub. Date: Feb. 10, 2005

(54) Epoxy compositions

(76) Inventors: Theodore R. Flint, Elverson, PA (US); Irvin D. Crossan, Glenmoore, PA (US)

Correspondence Address: DUANE MORRIS, LLP;IP DEPARTMENT, ONE LIBERTY PLACE, PHILADELPHIA, PA, 19103-7396, US

(21) Appl. No.: 10/633,759

(22) Filed: Aug. 4, 2003

(51) Int. Cl. C08L 63/00

(52) U.S. Cl. 523/400; 528/109

(57) ABSTRACT

The present invention relates to a non-sensitizing epoxy composition including an uncured epoxy resin composition including a liquid epoxy resin and a non-sensitizing mercaptan composition capable of curing said epoxy resin when combined with said mercaptan composition to form a substantially uniform mixture, wherein said epoxy resin has a molecular weight greater than about 700.

### BACKGROUND OF THE INVENTION

Epoxy putty sticks typically comprise an epoxy resin, fillers (e.g., talc), a polyether polymercaptan and an accelerator (e.g., tri(dimethylaminomethyl)phenol). A typical epoxy putty formulation contains the following components: 1) standard bisphenol A epoxy resin (mol. wt. 370); 2) sodium, potassium, aluminum and/or silicate filler; 3) magnesium silicate hydrate (talc); 4) powdered quartz filler; 5) metal powder; 6) tri(dimethylaminomethyl)phenol; and 7) polyether polymercaptan.

Epoxy sticks are normally sold as extruded concentric cylinders with the epoxy resin and fillers on the outside, and polyether polymercaptan, tri(dimethylaminomethyl)phenol and fillers on the inside. Note that in Europe, for instance, all commodities which contain epoxy resin greater than 1% need to have hazard labeling, with the exception of epoxy resins with a molecular weight of greater than 700. The epoxy putty sticks to be used need to be mixed, or kneaded, by hand. Users of such products (e.g., consumers) usually do not wear or have readily available hand protection, so there is the consequent potential for skin irritation or sensitization if hands are not washed after use, or upon repeated usage.

Therefore, it would be advantageous to employ an epoxy resin which would not have the potential to cause skin irritation. This would be the case if one could utilize an epoxy resin with a molecular weight of greater than about 700, with a molecular weight of greater than about 800 preferred. Note further that there are many epoxy resins available commercially which have a molecular weight of greater than 700; however, these are solid in form, and could not be used to formulate an epoxy putty without significant additions of plasticizers or diluents which would adversely affect the physical properties of the cured product.

### SUMMARY OF THE INVENTION

The present invention relates to an epoxy composition comprising an uncured epoxy resin composition including a liquid epoxy resin and a non-sensitizing mercaptan composition capable of curing said epoxy resin when combined with said mercaptan composition to form a substantially uniform mixture, wherein said epoxy resin has a molecular weight greater than about 700. In a preferred embodiment, the present invention relates to an epoxy composition comprising a first band of an uncured epoxy resin composition including a liquid epoxy resin and a second band, said bands being joined in close side-by-side relation throughout their entire length, said second band comprising a mercaptan composition capable of curing said epoxy resin when said first and second bands are combined to form a substantially uniform mixture, wherein the epoxy resin has a molecular weight of greater than about 700.

Preferably, the epoxy resin is about 20-30% by weight of the uncured epoxy resin composition, and possesses a molecular weight of from about 800 to 1,000. The epoxy resin may be admixed with fillers and colorants including talc, titanium dioxide, carbon black and mixtures thereof. A molecular weight of the epoxy resin of from about 900-950 is particularly preferred.

### DESCRIPTION OF THE PREFERRED EMBODIMENTS

The present invention relates to a sorbitol based epoxy resin which has a weight average molecular weight greater than about 700, and is still liquid. In a particularly preferred embodiment of the present invention, an epoxy resin with a molecular weight of 930 (available commercially as Erisys® GE-60 by CDC Specialty Chemicals, hereinafter sorbitol based epoxy resin) may be employed. This material is a sorbitol based epoxy resin, e.g., a sorbitol glycidyl ether-aliphatic polyfunctional epoxy resin. The epoxy compositions of the present invention may have the consistency of a stiff epoxy putty, or alternatively, a liquid or paste consistency. The following examples are included as being illustrative of the invention, and should not be construed as limiting the scope thereof.

### EXAMPLE 1

The preferred material was incorporated into epoxy putty formulations as follows:

| | |
|---|---|
| Sorbitol based epoxy resin | 27.1% |
| Quartz powder | 28.3% |
| Treated fumed Silica | 1.4% |
| Talc | 47.8% |
| Carbon Black | 0.8% |
| Metal powder | 0.7% |

In practice, when the above formulation was mixed 1/1 by weight with a standard mercaptan side containing the following materials, it cured in a manner similar to existing epoxy putties:

| | |
|---|---|
| Polyether polymercaptan | 18.8% |
| Tri(dimethylaminomethyl)phenol | 2.1% |
| Sodium, Potassium, Aluminum Silicate filler | 5.5% |
| Carbon Black | 0.05% |
| Talc | 33.2% |
| Metal powder | 38.7% |

The mixed product above cured in about 10 minutes, and gave lapshear strengths on steel in 24 hours of 330 psi, 660 psi and 360 psi. After about one hour of cure, lapshear on steel of 360 psi and 380 psi resulted; after about three days of cure, lapshear on steel of 684 psi and 780 psi resulted.

A control example, as shown below, resulted in similar properties:

Control example:

| | |
|---|---|
| Standard bisphenol A epoxy resin (MW 370) | 27% |
| Quartz powder | 28% |
| Treated Fumed Silica | 1.4% |
| Talc | 48% |
| Carbon Black | 0.8% |
| Metal powder | 0.7% |
| Polyether polymercaptan | 18.8% |
| Tri(dimethylaminomethyl)phenol | 2.1% |
| Sodium, Potassium, Aluminum Silicate filler | 5.5% |
| Carbon Black | 0.05% |
| Talc | 33.2% |
| Metal powder | 38.7% |

The mixed product cured in about 9 minutes and gave lapshear strengths on steel in 24 hours of 500 to 600 psi. On three days cure, lapshear on steel of 500-600 psi resulted.

### EXAMPLE 2

In further testing, an additional epoxy formulation was prepared using the following materials:

| | |
|---|---|
| Sorbitol based epoxy resin | 24.5% |
| 1/32 inch chopped glass | 19.2% |
| Quartz powder | 17.6% |
| Titanium Dioxide pigment | 7.1% |
| Talc | 31.6% |

When the above was mixed 1/1 by weight with a standard mercaptan side containing the following components, the resulting combination cured in about four minutes:

| | |
|---|---|
| Polyether polymercaptan | 21.9% |
| Talc | 70.1% |
| Sorbitol based epoxy resin | 2.3% |
| Tri(dimethylaminomethyl)phenol | 1.2% |
| Ultramarine blue pigment | 0.1% |

The combination product above had a Shore D hardness of 48 in 15 minutes, and a Shore D hardness of 76 in 24 hours. It also showed a lapshear strength of 375 psi to brass, 483 psi to steel and 535 psi to aluminum, after a 24-hour cure.

Thus, given that the epoxy putty formulations as described above contain only epoxy resin with a molecular weight of greater than about 700, these materials would fall into more acceptable handling categories. Note that these formulations may also be liquid, allowing further ease of handling the material.

In the testing of the present invention, the preferred epoxy resin with a molecular weight of 930 was found not to be a contact sensitizer. Specifically, dermal reactions in a group of guinea pigs subjected to dermal administration of the epoxy resin had dermal responses on the order of 0, as described below.

The experimental procedure was as follows:

Three pairs of intradermal injections were made in a shaved area on guinea pig animals used in the sensitization study. Injections for the test animals were as follows:
1. Injection Pair A—0.1 mL of FCA (Freund's Complete Adjuvant) emulsion.
2. Injection Pair B—0.1 mL of 5% w/v GE-60 epoxy resin/2% acetone/PEG 400.
3. Injection Pair C—0.1 mL of 5% w/v GE-60 epoxy resin/2% acetone/FCA emulsion.

Injections for the challenge and rechallenge control animals were as follows:
1. Injection Pair A—0.1 mL of FCA emulsion.
2. Injection Pair B—0.1 mL of 2% acetone/PEG 400.
3. Injection Pair C—0.1 mL of 5% w/v 2% acetone/PEG 400/FCA emulsion.

On the day prior to topical induction, the guinea pigs had hair removed, with care being taken to avoid abrading the skin during the clipping procedures. Following clipping, 0.5 ml of 10% w/w sodium lauryl sulfate in petrolatum was spread over the intradermal injection sites of all study animals. Any residual sodium lauryl sulfate preparation was subsequently removed with dry gauze, and the appropriate material was prepared and applied to the animals as follows:

| | | Concentration | Amount | |
|---|---|---|---|---|
| Group | Material | (%) | Applied | Patch Design |
| Test | Sorbitol based | 100 | 0.8 mL | 2 × 4 cm |
| | epoxy resin | | | Webril patch |
| Challenge | Acetone | 100 | 0.8 mL | 2 × 4 cm |
| Control | | | | Webril patch |
| Rechallenge | Acetone | 100 | 0.8 mL | 2 × 4 cm |
| Control | | | | Webril patch |

A patch was applied over the intradermal injection sites. Approximately 48 hours after dosing, the binding materials were removed; the tests sites were wiped with gauze moistened in deionized water, followed by dry gauze to remove the test article residue.

The sensitization potential of the material of the present invention was based on the dermal responses of the test and control animals. Generally, dermal scores greater than or equal to one in the test animals, with scores of about zero noted in the controls are considered indicative of sensitization. Dermal scores of about one in both the test and control animals are generally considered equivocal, unless a higher dermal response is noted in the test animals.

Following treatment with 100% sorbitol based epoxy resin, dermal reactions in the test and challenge control animals were limited to scores of approximately zero. Following rechallenge, dermal reactions produced similar results.

Using α-hexylcinnamaldehyde (HCA) as a positive control, and following intradermal induction at 5% w/v HCA in propylene glycol, topical induction at 5% w/v HCA in propylene glycol and challenge at 0.5% and 1% w/v HCA in propylene glycol resulted in a contact sensitization response being observed, thereby demonstrating the susceptibility of the test system to this sensitizing agent. Therefore, the preferred epoxy resin of the present invention was not considered to be a contact sensitizer in guinea pigs. The results of the HCA control study demonstrated that a valid test was performed, and indicated that the test design would detect potential contact sensitizers.

While this invention has been described with respect to particular embodiments thereof, it is apparent that numerous other forms and modifications of this invention will be obvious to those skilled in the art. The appended claims and this invention generally should be construed to cover all such obvious forms and modifications which are within the true spirit and scope of the present invention.

1. A non-sensitizing epoxy composition comprising:
an uncured epoxy resin composition including a liquid epoxy resin and a non-sensitizing mercaptan composition capable of curing said epoxy resin when combined with said mercaptan composition to form a substantially uniform mixture, wherein said epoxy resin has a molecular weight greater than about 700.

2. The composition as recited in claim 1, wherein said epoxy resin is about 20-30% by weight of said uncured epoxy resin composition.

3. The composition as recited in claim 1, wherein said epoxy resin has a molecular weight of about 800-1000.

4. The composition as recited in claim 1, wherein said epoxy resin is admixed with fillers and colorants selected from the group consisting of talc, titanium dioxide, carbon black and mixtures thereof.

5. The composition as recited in claim 3, wherein said epoxy resin has a molecular weight of from about 900-950.

6. The composition as recited in claim 1, wherein said liquid epoxy resin is a sorbitol glycidyl ether-aliphatic polyfunctional epoxy resin.

7. The composition as recited in claim 1, wherein said epoxy composition has the consistency of a stiff epoxy putty.

8. The composition as recited in claim 1, wherein said epoxy putty composition has the consistency of a liquid or paste.

9. A non-sensitizing epoxy composition comprising:
a first band of an uncured epoxy resin composition including a liquid epoxy resin and a second band, said bands being joined in close side-by-side relation throughout their entire length, said second band comprising a non-sensitizing mercaptan composition capable of curing said epoxy resin when said first and second bands are combined to form a substantially uniform mixture, wherein said epoxy resin has a molecular weight greater than about 700.

10. A method of forming a non-sensitizing epoxy putty composition, comprising:
combining an uncured epoxy resin composition including a liquid epoxy resin and a non-sensitizing mercaptan composition capable of curing said epoxy resin when combined with said mercaptan composition to form a substantially uniform mixture, wherein said epoxy resin has a molecular weight greater than about 700.

11. The method as recited in claim 10, wherein said epoxy resin is about 20-30% by weight of said uncured epoxy resin composition.

12. The method as recited in claim 10, wherein said epoxy resin has a molecular weight of about 800-1000.

13. The method as recited in claim 10, wherein said epoxy resin is admixed with fillers and colorants selected from the group consisting of talc, titanium dioxide, carbon black and mixtures thereof.

14. The method as recited in claim 10, wherein said epoxy resin has a molecular weight of from about 900-950.

15. The method as recited in claim 10, wherein said liquid epoxy resin is a sorbitol glycidyl ether-aliphatic polyfunctional epoxy resin.

16. The method as recited in claim 10, wherein said epoxy composition has the consistency of a stiff epoxy putty.

17. The method as recited in claim 10, wherein said epoxy putty composition has the consistency of a liquid or paste.
